(19) United States
(12) Patent Application Publication
(10) Pub. No.: US 2024/0337758 A1
(43) Pub. Date: Oct. 10, 2024

(54) GLOBAL NAVIGATION SATELLITE SYSTEM OPERATION WITH TRIGGERED GAPS

(71) Applicant: QUALCOMM Incorporated, San Diego, CA (US)

(72) Inventors: Alberto RICO ALVARINO, San Diego, CA (US); Bharat SHRESTHA, San Diego, CA (US); Le LIU, San Jose, CA (US); Umesh PHUYAL, San Diego, CA (US); Changhwan PARK, San Diego, CA (US); Ayan SENGUPTA, San Diego, CA (US); Sitaramanjaneyulu KANAMARLAPUDI, San Diego, CA (US); Xiao Feng WANG, San Diego, CA (US)

(21) Appl. No.: 18/537,361

(22) Filed: Dec. 12, 2023

Related U.S. Application Data
(60) Provisional application No. 63/494,657, filed on Apr. 6, 2023.

(51) Int. Cl. G01S 19/25

(52) U.S. Cl. CPC G01S 19/25

(57) ABSTRACT

Various aspects of the present disclosure generally relate to wireless communication. In some aspects, a user equipment (UE) may receive a trigger indicating that the UE is to perform a global navigation satellite system (GNSS) acquisition process within a GNSS measurement gap, wherein a start time of the GNSS measurement gap is based at least in part on whether hybrid automatic repeat request (HARQ) feedback is enabled for a channel in which the trigger is received. The UE may perform the GNSS acquisition process within the GNSS measurement gap based at least in part on the trigger. Numerous other aspects are described.

### CROSS-REFERENCE TO RELATED APPLICATION

This patent application claims priority to U.S. Provisional Patent Application No. 63/494,657, filed on Apr. 6, 2023, entitled “GLOBAL NAVIGATION SATELLITE SYSTEM OPERATION WITH TRIGGERED GAPS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for global navigation satellite system (GNSS) operation with triggered gaps.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a trigger indicating that the UE is to perform a global navigation satellite system (GNSS) acquisition process within a GNSS measurement gap, where a start time of the GNSS measurement gap is based at least in part on whether hybrid automatic repeat request (HARQ) feedback is enabled for a channel in which the trigger is received. The method may include performing the GNSS acquisition process within the GNSS measurement gap based at least in part on the trigger.

Some aspects described herein relate to a method of wireless communication performed by a UE. The method may include receiving a trigger indicating that the UE is to perform a GNSS acquisition process within a GNSS measurement gap. The method may include selectively performing the GNSS acquisition process within the GNSS measurement gap based at least in part on a determination of whether a remaining GNSS validity duration satisfies a threshold.

Some aspects described herein relate to a method of wireless communication performed by a UE. The method may include receiving a trigger indicating that the UE is to perform a GNSS acquisition process within a GNSS measurement gap. The method may include performing the GNSS acquisition process within the GNSS measurement gap based at least in part on the trigger, where a result of performing the GNSS acquisition process is a failure to reacquire GNSS within the GNSS measurement gap. The method may include performing a GNSS failure recovery process based at least in part on the failure to reacquire GNSS within the GNSS measurement gap.

Some aspects described herein relate to a UE for wireless communication. The UE may include a memory and one or more processors coupled to the memory. The one or more processors may be configured to receive a trigger indicating that the UE is to perform a GNSS acquisition process within a GNSS measurement gap, where a start time of the GNSS measurement gap is based at least in part on whether HARQ feedback is enabled for a channel in which the trigger is received. The one or more processors may be configured to perform the GNSS acquisition process within the GNSS measurement gap based at least in part on the trigger.

Some aspects described herein relate to a UE for wireless communication. The UE may include a memory and one or more processors coupled to the memory. The one or more processors may be configured to receive a trigger indicating that the UE is to perform a GNSS acquisition process within a GNSS measurement gap. The one or more processors may be configured to selectively perform the GNSS acquisition process within the GNSS measurement gap based at least in part on a determination of whether a remaining GNSS validity duration satisfies a threshold.

Some aspects described herein relate to a UE for wireless communication. The UE may include a memory and one or more processors coupled to the memory. The one or more processors may be configured to receive a trigger indicating that the UE is to perform a GNSS acquisition process within a GNSS measurement gap. The one or more processors may be configured to perform the GNSS acquisition process within the GNSS measurement gap based at least in part on the trigger, where a result of performing the GNSS acquisition process is a failure to reacquire GNSS within the GNSS measurement gap. The one or more processors may be configured to perform a GNSS failure recovery process based at least in part on the failure to reacquire GNSS within the GNSS measurement gap.

Some aspects described herein relate to a non-transitory computer-readable medium that stores a set of instructions for wireless communication by a UE. The set of instructions, when executed by one or more processors of the UE, may cause the UE to receive a trigger indicating that the UE is to perform a GNSS acquisition process within a GNSS measurement gap, where a start time of the GNSS measurement gap is based at least in part on whether HARQ feedback is enabled for a channel in which the trigger is received. The set of instructions, when executed by one or more processors of the UE, may cause the UE to perform the GNSS acquisition process within the GNSS measurement gap based at least in part on the trigger.

Some aspects described herein relate to a non-transitory computer-readable medium that stores a set of instructions for wireless communication by a UE. The set of instructions, when executed by one or more processors of the UE, may cause the UE to receive a trigger indicating that the UE is to perform a GNSS acquisition process within a GNSS measurement gap. The set of instructions, when executed by one or more processors of the UE, may cause the UE to selectively perform the GNSS acquisition process within the GNSS measurement gap based at least in part on a determination of whether a remaining GNSS validity duration satisfies a threshold.

Some aspects described herein relate to a non-transitory computer-readable medium that stores a set of instructions for wireless communication by a UE. The set of instructions, when executed by one or more processors of the UE, may cause the UE to receive a trigger indicating that the UE is to perform a GNSS acquisition process within a GNSS measurement gap. The set of instructions, when executed by one or more processors of the UE, may cause the UE to perform the GNSS acquisition process within the GNSS measurement gap based at least in part on the trigger, where a result of performing the GNSS acquisition process is a failure to reacquire GNSS within the GNSS measurement gap. The set of instructions, when executed by one or more processors of the UE, may cause the UE to perform a GNSS failure recovery process based at least in part on the failure to reacquire GNSS within the GNSS measurement gap.

Some aspects described herein relate to an apparatus for wireless communication. The apparatus may include means for receiving a trigger indicating that the apparatus is to perform a GNSS acquisition process within a GNSS measurement gap, where a start time of the GNSS measurement gap is based at least in part on whether HARQ feedback is enabled for a channel in which the trigger is received. The apparatus may include means for performing the GNSS acquisition process within the GNSS measurement gap based at least in part on the trigger.

Some aspects described herein relate to an apparatus for wireless communication. The apparatus may include means for receiving a trigger indicating that the apparatus is to perform a GNSS acquisition process within a GNSS measurement gap. The apparatus may include means for selectively performing the GNSS acquisition process within the GNSS measurement gap based at least in part on a determination of whether a remaining GNSS validity duration satisfies a threshold.

Some aspects described herein relate to an apparatus for wireless communication. The apparatus may include means for receiving a trigger indicating that the apparatus is to perform a GNSS acquisition process within a GNSS measurement gap. The apparatus may include means for performing the GNSS acquisition process within the GNSS measurement gap based at least in part on the trigger, where a result of performing the GNSS acquisition process is a failure to reacquire GNSS within the GNSS measurement gap. The apparatus may include means for performing a GNSS failure recovery process based at least in part on the failure to reacquire GNSS within the GNSS measurement gap.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example associated with global navigation satellite system (GNSS) operation with triggered gaps, in accordance with the present disclosure.

FIGS. 5A-5C are diagrams associated with an example associated with GNSS operation with triggered gaps, in accordance with the present disclosure.

FIGS. 6A-6E are diagrams associated with an example associated with GNSS operation with triggered gaps, in accordance with the present disclosure.

FIG. 7 is a diagram illustrating an example associated with GNSS operation with triggered gaps, in accordance with the present disclosure.

FIG. 8 is a diagram illustrating an example process performed, for example, by a UE, in accordance with the present disclosure.

FIG. 9 is a diagram illustrating an example process performed, for example, by a UE, in accordance with the present disclosure.

FIG. 10 is a diagram illustrating an example process performed, for example, by a UE, in accordance with the present disclosure.

FIG. 11 is a diagram of an example apparatus for wireless communication, in accordance with the present disclosure.

### DETAILED DESCRIPTION

In some systems, a duration of a non-terrestrial network (NTN) connection between a user equipment (UE) and a network node (e.g., a non-terrestrial network node) can be extended to enable larger data transfers and conserve UE power resources. One technique for extending the duration of the NTN connection utilizes a global navigation satellite system (GNSS) measurement gap trigger. However, operation of the UE with respect to implementation of a triggered GNSS measurement gap needs definition. For example, a time at which the GNSS measurement gap starts must be defined. As another example, due to timing misalignment between the network node and the UE, the UE may in some scenarios receive the trigger long before expiration of the GNSS validity duration. In such a scenario, performing GNSS acquisition too early would be wasteful of UE power resources. Therefore, operation of the UE in case of receiving an early trigger must be defined. As another example, the UE may perform GNSS acquisition within the GNSS measurement gap, but may fail to acquire GNSS within the GNSS measurement gap. Therefore, operation of the UE in case of a GNSS acquisition failure within the GNSS measurement gap must be defined.

Various aspects relate generally to wireless communication and more particularly to GNSS operation with triggered gaps. Some aspects more specifically relate to UE behavior in various scenarios as related to a GNSS measurement gap triggered by a network node. In some examples, a UE may receive a trigger indicating that the UE is to perform a GNSS acquisition process within a GNSS measurement gap. In some aspects, a start time of the GNSS measurement gap is based at least in part on whether HARQ feedback is enabled for a channel in which the trigger is received. In some aspects, the UE may perform the GNSS acquisition process within the GNSS measurement gap based at least in part on the trigger. For example, in some aspects, the UE may perform the GNSS acquisition process within the GNSS measurement gap based at least in part on the trigger. Additionally, or alternatively, the UE may selectively perform the GNSS acquisition process within the GNSS measurement gap based at least in part on a determination of whether a remaining GNSS validity duration satisfies a threshold. In some aspects, the UE may perform the GNSS acquisition process within the GNSS measurement gap based at least in part on the trigger, and a result of performing the GNSS acquisition process may be a failure to reacquire GNSS. Here, the UE may perform a GNSS failure recovery process based at least in part on the failure to reacquire GNSS within the GNSS measurement gap.

Particular aspects of the subject matter described in this disclosure can be implemented to realize one or more of the following potential advantages. In some examples, UE behavior in response to a triggered GNSS measurement gap is defined. For example, a time at which the GNSS measurement gap starts may be defined based at least in part on whether HARQ is enabled for a channel in which the trigger is received, thereby enabling coordination of the UE and the network node with respect to start of the GNSS measurement gap. Further, behavior of the UE in case of receiving an early trigger may be defined so as to cause the UE to perform the GNSS acquisition process only when the GNSS validity duration satisfies a threshold (e.g., is less than or equal to a threshold amount of time), thereby conserving UE power resources (e.g., by preventing unneeded performances of GNSS acquisition). Additionally, behavior of the UE in case of a failure to acquire GNSS within the GNSS measurement gap may be defined so that the UE recovers from the GNSS acquisition failure. In this way, the use of a GNSS measurement gap trigger may be supported so as to enable a duration of an NTN connection to be extended using a GNSS measurement gap trigger when appropriate, thereby improving efficiency of NTN communication and conserving UE power resources.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

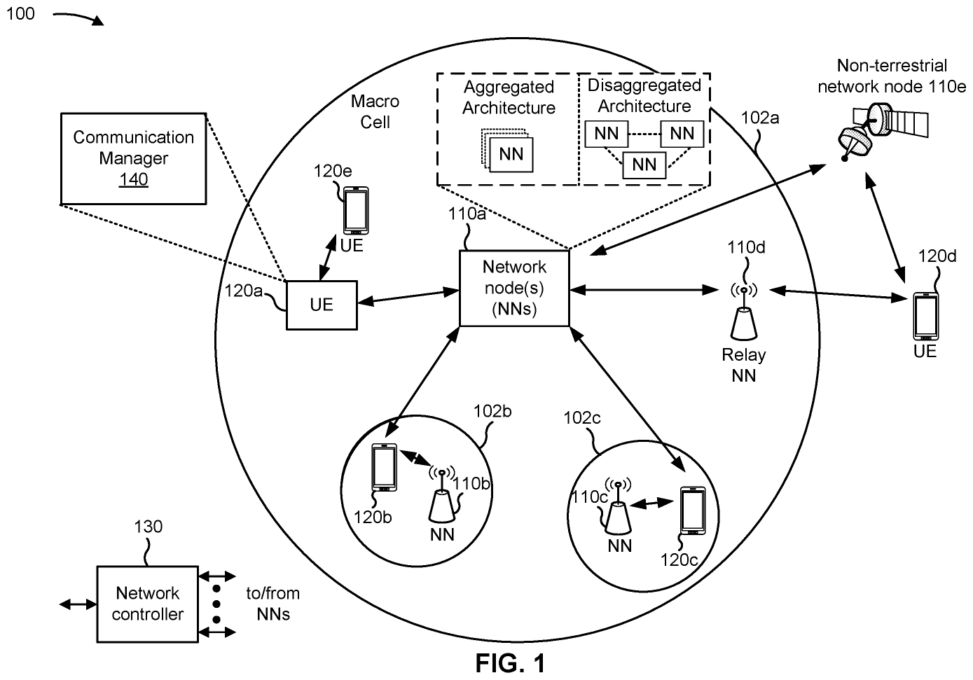

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHZ-7.125 GHZ) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the wireless network 100 may include one or more non-terrestrial network (NTN) deployments in which a non-terrestrial wireless communication device may include a network node 110. Such a network node 110 is sometimes referred to as a non-terrestrial network node 110 (e.g., network node 110e in FIG. 1). As used herein, an NTN may refer to a network for which access is facilitated by one or more non-terrestrial network nodes 110 and/or one or more other types of a non-terrestrial wireless communication devices, such as one or more non-terrestrial relay stations.

In some aspects, the wireless network 100 may include any number of non-terrestrial wireless communication devices. A non-terrestrial wireless communication device may include, for example, a satellite or a high-altitude platform (HAP). A HAP may include a balloon, a dirigible, an airplane, and/or an unmanned aerial vehicle. A non-terrestrial wireless communication device may be part of an NTN that is separate from the wireless network 100. Alternatively, an NTN may be part of the wireless network 100. In some aspects, satellites may communicate directly and/or indirectly with other entities in wireless network 100 using satellite communication. The other entities may include UEs (e.g., UEs 120), other satellites in the one or more NTN deployments (e.g., other network nodes 110), other types of network nodes (e.g., stationary or ground-based network nodes), relay stations, and/or one or more components and/or devices included in a core network of wireless network 100.

In some aspects, the UE 120 may include a communication manager 140. As described in more detail elsewhere herein, the communication manager 140 may receive a trigger indicating that the UE 120 is to perform a global navigation satellite system (GNSS) acquisition process within a GNSS measurement gap, wherein a start time of the GNSS measurement gap is based at least in part on whether hybrid automatic repeat request (HARQ) feedback is enabled for a channel in which the trigger is received; and perform the GNSS acquisition process within the GNSS measurement gap based at least in part on the trigger.

Additionally, or alternatively, as described in more detail elsewhere herein, the communication manager 140 may receive a trigger indicating that the UE 120 is to perform a GNSS acquisition process within a GNSS measurement gap; and selectively perform the GNSS acquisition process within the GNSS measurement gap based at least in part on a determination of whether a remaining GNSS validity duration satisfies a threshold.

Additionally, or alternatively, as described in more detail elsewhere herein, the communication manager 140 may receive a trigger indicating that the UE 120 is to perform a GNSS acquisition process within a GNSS measurement gap; perform the GNSS acquisition process within the GNSS measurement gap based at least in part on the trigger, wherein a result of performing the GNSS acquisition process is a failure to reacquire GNSS within the GNSS measurement gap; and perform a GNSS failure recovery process based at least in part on the failure to reacquire GNSS within the GNSS measurement gap.

Additionally, or alternatively, the communication manager 140 may perform one or more other operations described herein.

As indicated above, FIG. 1 is provided as an example. Other examples may differ from what is described with regard to FIG. 1.

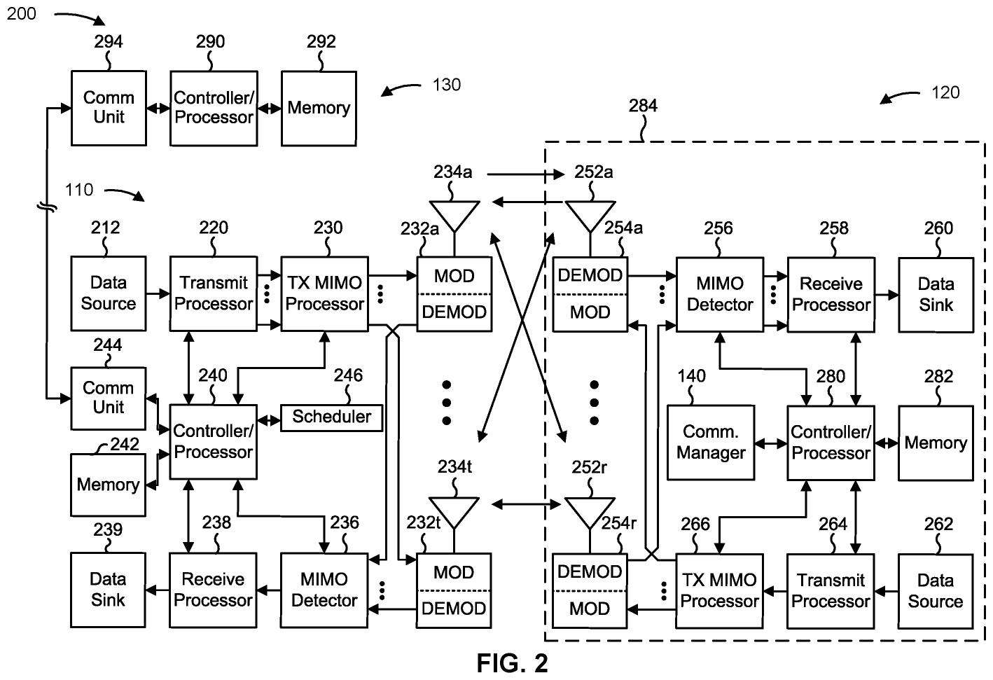

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

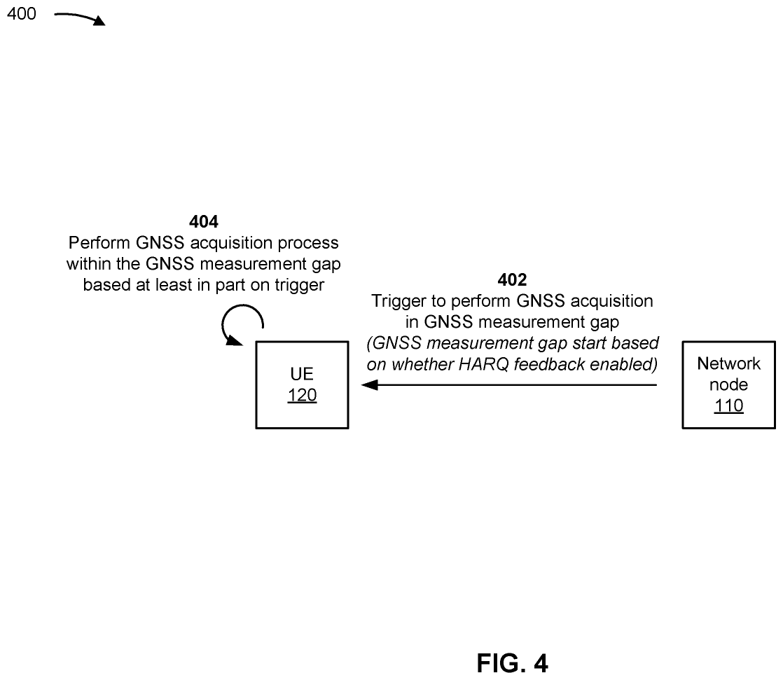

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-11).

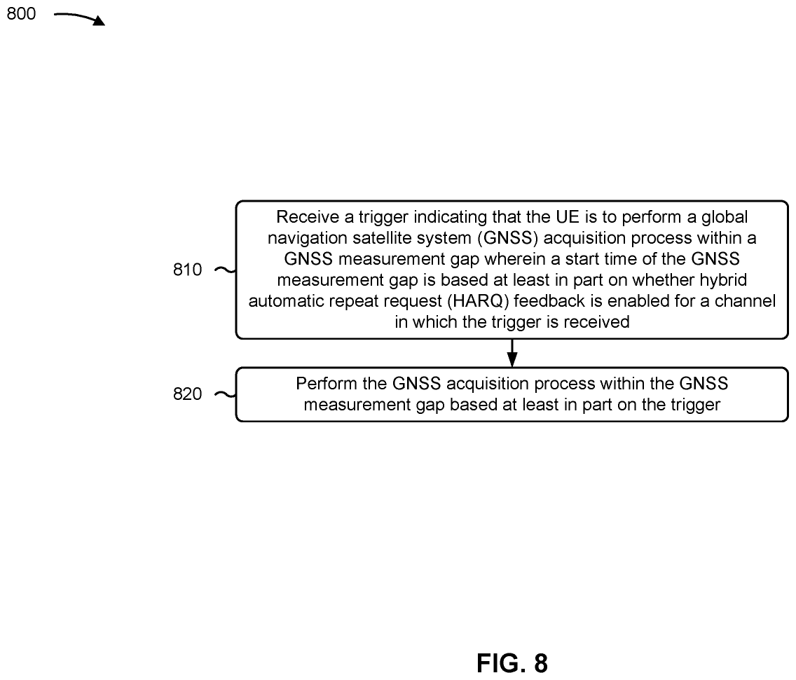

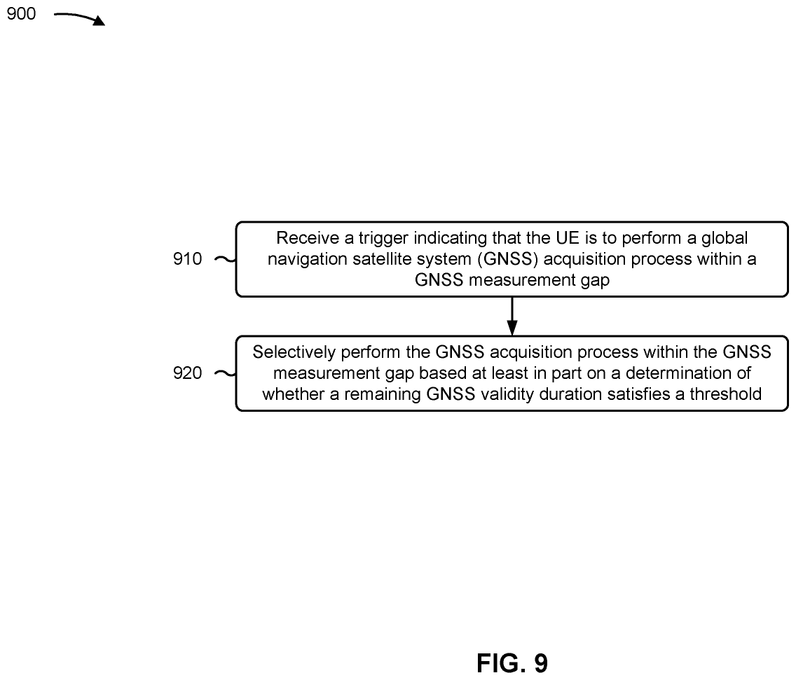

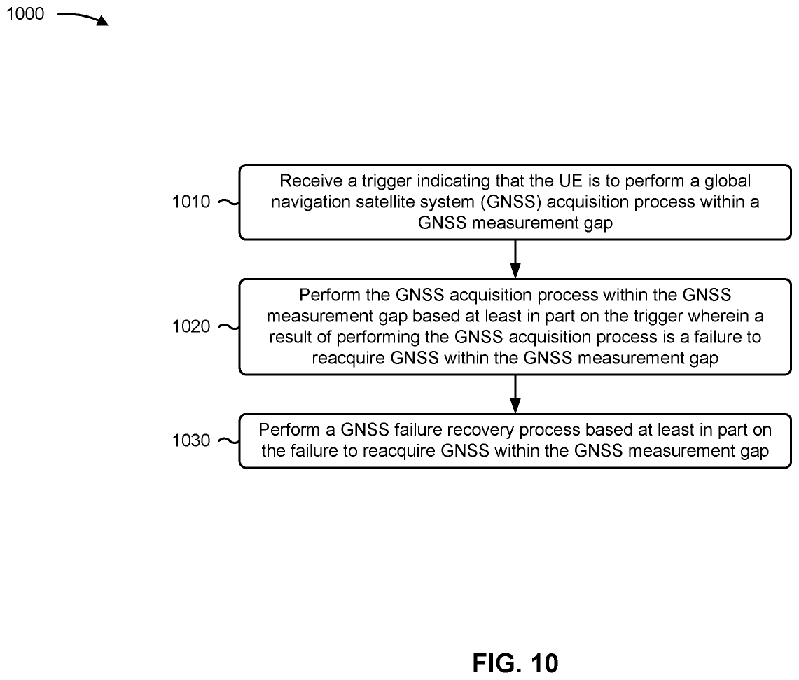

The controller/processor 240 of the network node 110, the controller/processor 280 of the UE 120, and/or any other component(s) of FIG. 2 may perform one or more techniques associated with GNSS operation with triggered gaps, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving a trigger indicating that the UE is to perform a GNSS acquisition process within a GNSS measurement gap, wherein a start time of the GNSS measurement gap is based at least in part on whether HARQ feedback is enabled for a channel in which the trigger is received; and/or means for performing the GNSS acquisition process within the GNSS measurement gap based at least in part on the trigger.

Additionally, or alternatively, the UE 120 includes means for receiving a trigger indicating that the UE is to perform a GNSS acquisition process within a GNSS measurement gap; and/or means for selectively performing the GNSS acquisition process within the GNSS measurement gap based at least in part on a determination of whether a remaining GNSS validity duration satisfies a threshold.

Additionally, or alternatively, the UE 120 includes means for receiving a trigger indicating that the UE is to perform a GNSS acquisition process within a GNSS measurement gap; means for performing the GNSS acquisition process within the GNSS measurement gap based at least in part on the trigger, wherein a result of performing the GNSS acquisition process is a failure to reacquire GNSS within the GNSS measurement gap; and/or means for performing a GNSS failure recovery process based at least in part on the failure to reacquire GNSS within the GNSS measurement gap.

The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

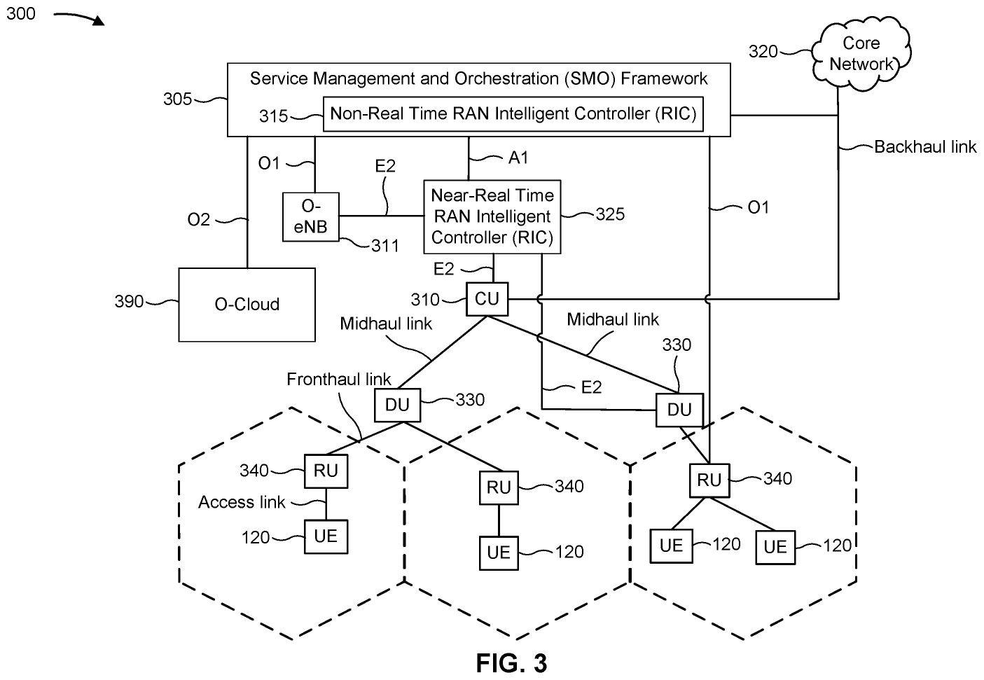

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUS 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as AI interface policies).

As indicated above, FIG. 3 is provided as an example. Other examples may differ from what is described with regard to FIG. 3.

In order to support NTN communication (e.g., communication between a UE 120 and a non-terrestrial network node 110), a UE must have knowledge of its own position. Therefore, before accessing an NTN system, a UE should perform GNSS acquisition, which allows the UE to determine a location of the UE. For some types of UE, such as an eMTC UE or an NB-IoT UE, complexity constraints may require that the UE can participate in either wireless communication or perform GNSS acquisition at a given time (i.e., an NB-IoT UE may not be capable of transmitting or receiving NB-IoT communications while also performing GNSS acquisition). With respect to GNSS operation, the UE determines (e.g., based on a mobility pattern of the UE) a GNSS validity duration that indicates an amount of time that a previous GNSS acquisition is valid. Conventionally, upon expiration of the GNSS validity duration, the NTN connection of the UE is removed and the UE moves to idle mode operation until the UE reacquires GNSS. In some systems, a duration of the NTN connection (e.g., an amount of time the UE operates in connected mode) can be extended. Extending the duration of the NTN connection can enable larger data transfers and conserve UE power resources (e.g., by reducing a frequency of GNSS (re) acquisition by the UE).

One technique for extending the duration of the NTN connection utilizes a GNSS measurement gap trigger. According to this technique, as the expiration of the GNSS validity duration approaches, a network node may transmit, and a UE may receive, a MAC control element (MAC-CE) that includes a trigger for a GNSS measurement gap. The GNSS measurement gap may be defined, for example, as a timer or as a period of time during which the UE is not required to receive or transmit any data to or from the network node. Notably, during the GNSS measurement gap, the UE is to perform GNSS acquisition and, therefore, does not receive or transmit communications via the NTN connection. However, according to this technique, the NTN connection is maintained despite the UE ceasing communication during the GNSS measurement gap. The network node may buffer data to transmit to the UE when the UE returns to the NTN connection, but does not expect the UE to transmit/receive on the NTN connection during the GNSS measurement gap.

However, operation of the UE with respect to implementation of a triggered GNSS measurement gap needs definition. For example, a time at which the GNSS measurement gap starts must be defined. As another example, due to timing misalignment between the network node and the UE, the UE may in some scenarios receive the trigger long before expiration of the GNSS validity duration. In such a scenario, performing GNSS acquisition too early would be wasteful of UE power resources. Therefore, operation of the UE in case of receiving an early trigger must be defined. As another example, the UE may perform GNSS acquisition within the GNSS measurement gap, but may fail to acquire GNSS within the GNSS measurement gap. Therefore, operation of the UE in case of a GNSS acquisition failure within the GNSS measurement gap must be defined.

Some aspects described herein provide techniques and apparatuses for GNSS operation with triggered gaps. In some aspects, a UE may receive a trigger indicating that the UE is to perform a GNSS acquisition process within a GNSS measurement gap. In some aspects, a start time of the GNSS measurement gap is based at least in part on whether HARQ feedback is enabled for a channel in which the trigger is received. In some aspects, the UE may perform the GNSS acquisition process within the GNSS measurement gap based at least in part on the trigger. For example, in some aspects, the UE may perform the GNSS acquisition process within the GNSS measurement gap based at least in part on the trigger. Additionally, or alternatively, the UE may selectively perform the GNSS acquisition process within GNSS measurement gap based at least in part on a determination of whether a remaining GNSS validity duration satisfies a threshold. In some aspects, the UE may perform the GNSS acquisition process within the GNSS measurement gap based at least in part on the trigger, and a result of performing the GNSS acquisition process may be a failure to reacquire GNSS. In some aspects, the UE may perform a GNSS failure recovery process based at least in part on the failure to reacquire GNSS within the GNSS measurement gap.

In this way, operation of the UE with respect to implementation of a triggered GNSS measurement gap may be defined. For example, a time at which the GNSS measurement gap starts may be defined based at least in part on whether HARQ is enabled for a channel in which the trigger is received, thereby enabling coordination of the start of the GNSS measurement gap between the UE and the network node. Further, operation of the UE in case of receiving an early trigger may be defined so as to cause the UE to perform the GNSS acquisition process only when the GNSS validity duration satisfies a threshold (e.g., is less than or equal to a threshold amount of time), thereby conserving UE power resources (e.g., by preventing unneeded GNSS acquisition). Additionally, operation of the UE in case of a failure to acquire GNSS within the GNSS measurement gap may be defined so that the UE recovers from the GNSS acquisition failure, thereby enabling NTN communication to resume in a timely manner. In this way, the use of a GNSS measurement gap trigger may be supported so as to enable a duration of an NTN connection to be extended, when appropriate, thereby improving efficiency of NTN communication and conserving UE resources. Additional details are provided below.

FIG. 4 is a diagram illustrating an example 400 associated with GNSS operation with triggered gaps, in accordance with the present disclosure. As shown in FIG. 4, example 400 includes communication between UE 120 and a network node 110 (e.g., a non-terrestrial network node 110). In some aspects, the UE 120 and the network node 110 may be included in a wireless network, such as wireless network 100. The UE 120 and the network node 110 may communicate via a wireless access link, which may include an uplink and a downlink.

As shown by reference 402, the network node 110 may transmit, and the UE 120 may receive, a trigger indicating that the UE 120 is to perform a GNSS acquisition process within a GNSS measurement gap. In some aspects, a start time of the GNSS measurement gap may be based at least in part on whether HARQ feedback is enabled for a channel in which the trigger is received. For example, the network node 110 may transmit, and the UE 120 may receive, the trigger in a MAC-CE carried in a physical downlink shared channel (PDSCH). Here, the start time of the GNSS measurement gap may be based at least in part on whether HARQ feedback is enabled for the PDSCH in which the UE 120 receives the MAC-CE carrying the trigger. The GNSS measurement gap may be defined, for example, as a timer or as a period of time during which the UE 120 is not required to receive or transmit any data to or from the network node 110.

In some aspects, the start time of the GNSS measurement gap is a particular amount of time after a transmission of a HARQ acknowledgment (ACK) associated with the trigger based on HARQ feedback being enabled for the channel in which the trigger is received. For example, if HARQ feedback is enabled for a PDSCH in which the MAC-CE carrying the trigger is received, then the start time of the GNSS measurement gap may be k milliseconds (ms) (k≥0) after the UE 120 transmits a HARQ-ACK associated with the MAC-CE (e.g., k ms after the end of the HARQ-ACK transmission).

Alternatively, the start time of the GNSS measurement gap may, in some aspects, be a particular amount of time after an end of reception of the channel in which the trigger is received, based on HARQ feedback being disabled for the channel in which the trigger is received. For example, if HARQ feedback is disabled for a PDSCH in which the MAC-CE carrying the trigger is received, then the start time of the GNSS measurement gap may be k′ ms (k′≥0) after the end of the reception of the PDSCH.

In some aspects, definition of the start time of the GNSS measurement gap in such a manner enables the GNSS measurement gap to start at a predictable point in time with respect to the trigger (e.g., a predictable subframe with respect to the trigger). In this way, coordination of the start time of the GNSS measurement gap between the UE 120 and the network node 110 can be achieved.

As shown by reference 404, the UE 120 may perform the GNSS acquisition process within the GNSS measurement gap based at least in part on the trigger. That is, the UE 120 may receive the trigger and, based at least in part on the trigger, may perform the GNSS acquisition process within the GNSS measurement gap. In some implementations, the UE 120 may perform the GNSS acquisition process automatically (e.g., the trigger may trigger the UE 120 to perform the GNSS acquisition process). In some implementations, the UE 120 may selectively perform the GNSS acquisition process (e.g., by either performing the GNSS acquisition process within the GNSS measurement gap or refraining from performing the GNSS acquisition process within the GNSS measurement gap).

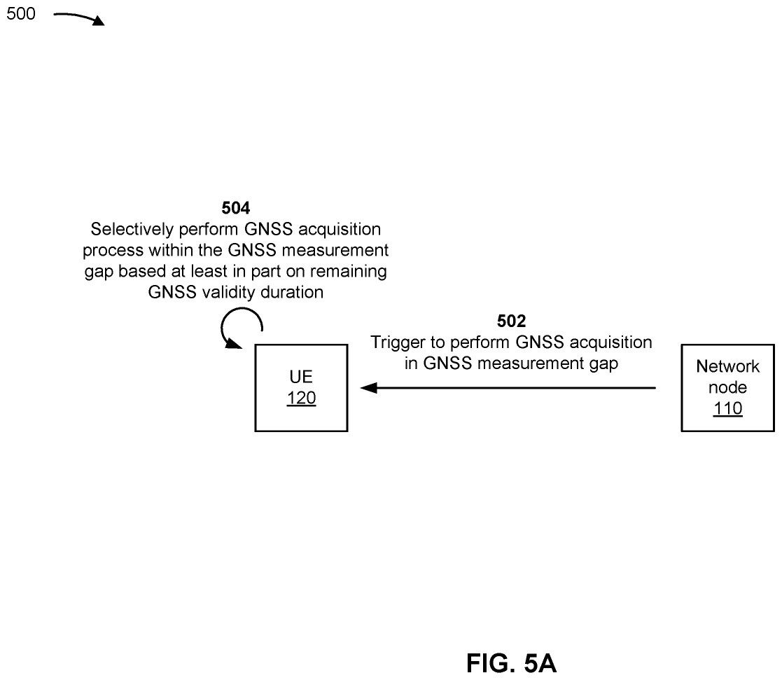

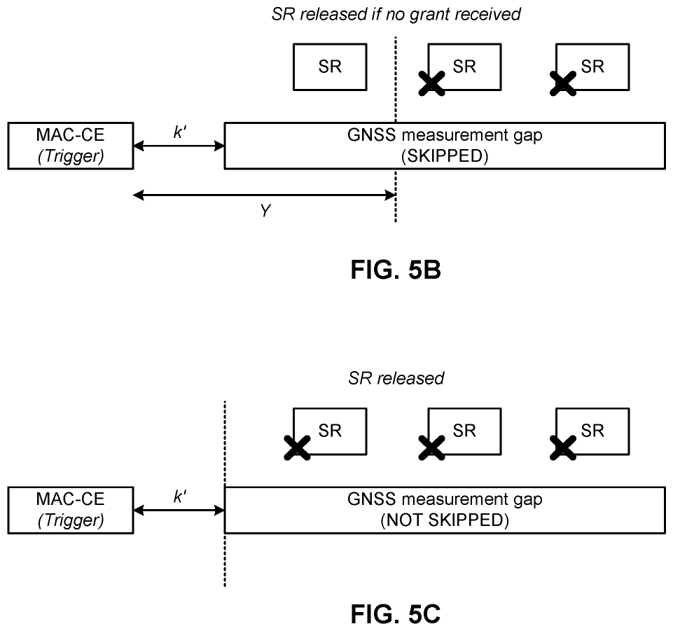

In some aspects, selectively performing the GNSS acquisition process includes refraining from performing the GNSS acquisition process based at least in part on a determination that a remaining GNSS validity duration satisfies a threshold (e.g., is greater than or equal to the threshold). Alternatively, selectively performing the GNSS acquisition process may include performing the GNSS acquisition process based at least in part on a determination that the remaining GNSS validity duration fails to satisfy the threshold (e.g., is less than the threshold). FIGS. 5A-5C illustrate examples associated with selective performance of the GNSS acquisition process based at least in part on whether a remaining GNSS validity duration satisfies a threshold.

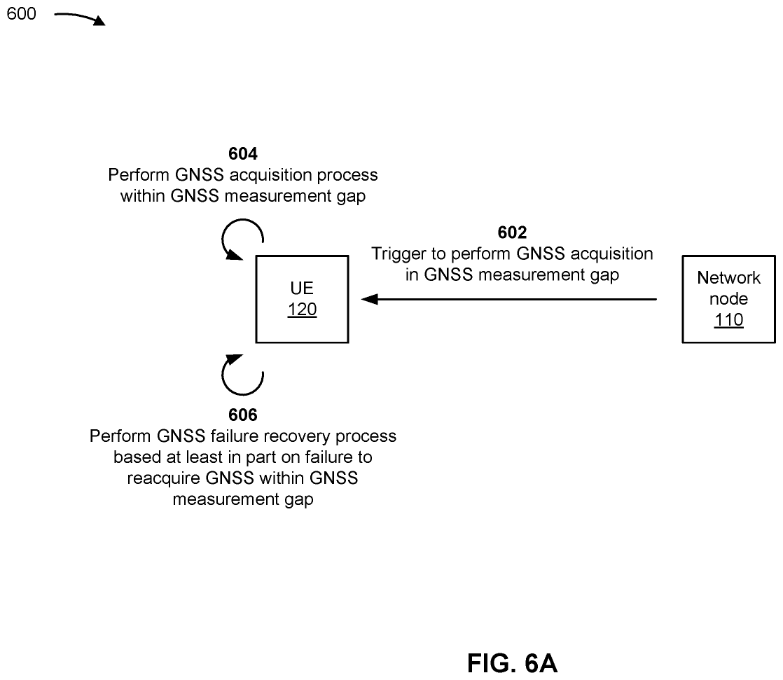

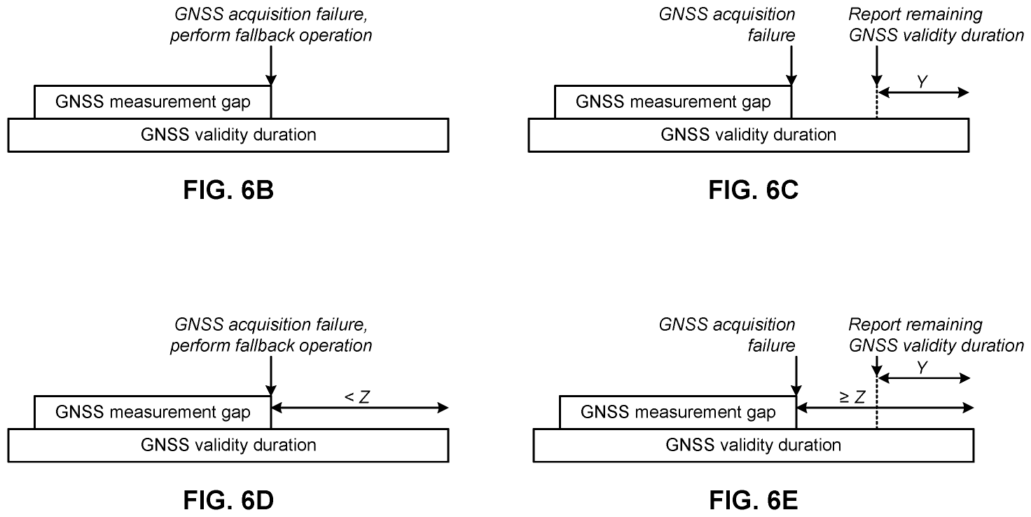

In some aspects, performing or selectively performing the GNSS acquisition process includes performing the GNSS acquisition process, and a result of performing the GNSS acquisition process is a failure to reacquire GNSS within the GNSS measurement gap. In some aspects, the UE 120 may perform a GNSS failure recovery process based at least in part on the failure to reacquire GNSS within the GNSS measurement gap. FIGS. 6A-6E illustrate examples associated with performance of a failure recovery process after a failure to reacquire GNSS within the GNSS measurement gap.

As indicated above, FIG. 4 is provided as an example. Other examples may differ from what is described with respect to FIG. 4.

FIGS. 5A-5C are diagrams associated with an example 500 associated with GNSS operation with triggered gaps, in accordance with the present disclosure. As shown in FIG. 5A, example 500 includes communication between UE 120 and a network node 110 (e.g., a non-terrestrial network node 110). In some aspects, the UE 120 and the network node 110 may be included in a wireless network, such as wireless network 100. The UE 120 and the network node 110 may communicate via a wireless access link, which may include an uplink and a downlink.

As shown by reference 502, the network node 110 may transmit, and the UE 120 may receive, a trigger indicating that the UE 120 is to perform a GNSS acquisition process within a GNSS measurement gap. In some aspects, a start time of the GNSS measurement gap may be based at least in part on whether HARQ feedback is enabled for a channel in which the trigger is received, as described, for example, with respect to FIG. 4.

As shown by reference 504, the UE 120 may selectively perform the GNSS acquisition process within the GNSS measurement gap based at least in part on a determination of whether a remaining GNSS validity duration satisfies a threshold. The remaining GNSS validity duration is an amount of time remaining in a GNSS validity duration associated with the UE 120. Here, the threshold may be a minimum remaining GNSS validity duration (e.g., the minimum amount that the UE 120 can signal to be a remaining validity duration). Thus, in one example, the UE 120 may refrain from performing the GNSS acquisition process within the GNSS measurement gap if the UE 120 determines that the remaining GNSS validity duration satisfies the threshold (e.g., is greater than or equal to the minimum remaining GNSS validity duration). In another example, the UE 120 may perform the GNSS acquisition process within the GNSS measurement gap if the UE 120 determines that the remaining GNSS validity duration fails to satisfy the threshold (e.g., is less than the minimum remaining GNSS validity duration).

In some aspects, the threshold is configured on the UE 120 (e.g., according to an applicable wireless communication standard). Additionally, or alternatively, the threshold may correspond to a fraction (e.g., a percentage) of a GNSS validity duration. That is, in some aspects, the threshold may be based at least in part on the GNSS validity duration (e.g., the threshold may be equal to 10% of the previously reported GNSS validity duration). Additionally, or alternatively, the threshold may be indicated in a configuration received from the network node 110. Additionally, or alternatively, the threshold may be determined or stored on the UE 120, and the UE 120 may signal the threshold to the network node 110 in, for example, UE capability information or UE assistance information.

In some aspects, as noted above, selectively performing the GNSS acquisition process includes refraining from performing the GNSS acquisition process based at least in part on a determination that the remaining GNSS validity duration satisfies the threshold. That is, the UE 120 may determine that the remaining GNSS validity duration satisfies the threshold, and the UE 120 may skip the GNSS acquisition process within the GNSS measurement gap indicated by the trigger. In some aspects, the UE 120 may indicate to the network node 110 that the UE 120 has refrained from performing the GNSS acquisition process within the GNSS measurement gap.

In some aspects, the indication that the UE 120 has skipped the GNSS acquisition process within the GNSS measurement gap may include an indication of the remaining GNSS validity duration. Thus, in some aspects, the UE 120 may transmit an indication of the remaining GNSS validity duration.

In some aspects, the UE 120 may perform a random access procedure in association with transmitting the indication of the remaining GNSS validity duration. For example, the UE 120 may be configured to release a set of scheduling request resources configured for the UE 120 upon receipt of the trigger. In such a scenario, the UE 120, after releasing the set of scheduling request resources, may perform a contention-based random access procedure, during which the UE 120 may transmit (e.g., in Msg3) the indication of the remaining GNSS validity duration.

Alternatively, the UE 120 may transmit the indication of the remaining GNSS validity duration based at least in part on an uplink grant. For example, the UE 120 may be configured to refrain from releasing a set of scheduling request resources configured for the UE 120 (e.g., despite receiving the trigger). In such a scenario, the UE 120 may transmit, and the network node 110 may receive, a scheduling request in the set of scheduling request resources. The network node 110 may transmit, and the UE 120 may receive, an uplink grant responsive to the scheduling request. The UE 120 may then transmit, and the network node 110 may receive, the indication of the remaining GNSS validity duration based at least in part on the uplink grant. In some aspects, to ensure that the UE 120 and the network node 110 are coordinated with respect to the validity of the set of scheduling request resources, the UE 120 may be configured to consider the set of scheduling request resources valid for a period of time (e.g., Y ms (Y≥0)) after the reception of the channel in which the trigger is received or after a transmission of a HARQ-ACK associated with the trigger (e.g., depending on whether HARQ feedback is enabled for the channel). Thus, in some aspects, the UE 120 may release the set of scheduling request resources if no uplink grant has been received during the period of time starting from an end of reception of the channel in which the trigger is received or from a transmission of the HARQ-ACK associated with the trigger. That is, if the UE 120 does not receive agrant (e.g., an uplink grant including the cell radio network temporary identifier (C-RNTI) associated with the network node 110) during the period of time, then the UE 120 may release the set of scheduling request resources.

Additionally, or alternatively, the indication that the UE 120 has skipped the GNSS acquisition process within the GNSS measurement gap may include an explicit indication that the UE 120 refrained from performing the GNSS acquisition process. In some aspects, the indication that the UE refrained from performing the GNSS acquisition process may be transmitted via HARQ feedback associated with the trigger. For example, the UE 120 may indicate in HARQ feedback to the MAC-CE carrying the trigger whether the GNSS measurement gap was used by the UE 120 (e.g., by transmitting a negative ACK (NACK) in case the GNSS measurement gap is to be skipped). In some aspects, the UE 120 may transmit an indication of the remaining GNSS validity duration in addition to the explicit indication that the UE 120 has skipped the GNSS measurement gap.

FIG. 5B is a diagram illustrating an example in which the UE 120 releases a set of scheduling request resources based at least in part on the UE 120 not receiving a grant in response to a scheduling request transmitted by the UE 120 as described above. In the example shown in FIG. 5B, HARQ feedback is disabled for a channel in which a MAC-CE trigger is received, and so a start time of a GNSS measurement gap associated with the trigger is k′ ms after an end of reception of the channel. Further, in this example, the UE 120 determines that a remaining GNSS validity duration satisfies a threshold (e.g., that the remaining GNSS validity duration is greater than or equal to a minimum remaining GNSS validity duration), and so the UE 120 refrains from performing the GNSS acquisition process within the GNSS measurement gap. The UE 120 in this example is configured such that the UE 120 does not release a set of scheduling request resources after receiving the trigger. Thus, the UE 120 may transmit a scheduling request in a first subset of scheduling request resources (e.g., such that the UE 120 can inform the network node 110 that the UE 120 has skipped the GNSS measurement gap). In this example, the UE 120 does not receive a grant (e.g., an uplink grant) within Y ms of the end of the reception of the channel, and so the UE 120 releases the set of scheduling request resources after Y ms from the end of the reception of the channel.

FIG. 5C is a diagram illustrating an example in which the UE 120 releases a set of scheduling request resources based at least in part on the UE 120 performing a GNSS acquisition process as described above. In the example shown in FIG. 5C. HARQ feedback is disabled for a channel in which a MAC-CE trigger is received, and so a start time of a GNSS measurement gap associated with the trigger is k′ms after an end of reception of the channel. Further, in this example, the UE 120 determines that a remaining GNSS validity duration fails to satisfy a threshold (e.g., that the remaining GNSS validity duration is less than the minimum remaining GNSS validity duration), and so the UE 120 performs the GNSS acquisition process within the GNSS measurement gap. In this example, the UE 120 releases the set of scheduling request resources at the start of the gap (e.g., since the UE 120 will be performing the GNSS acquisition process within the GNSS measurement gap).

As indicated above, FIGS. 5A-5C are provided as examples. Other examples may differ from what is described with respect to FIGS. 5A-5C.

FIGS. 6A-6E are diagrams associated with an example 600 associated with GNSS operation with triggered gaps, in accordance with the present disclosure. As shown in FIG. 6A, example 600 includes communication between the UE 120 and a network node 110 (e.g., a non-terrestrial network node 110). In some aspects, the UE 120 and the network node 110 may be included in a wireless network, such as wireless network 100. The UE 120 and the network node 110 may communicate via a wireless access link, which may include an uplink and a downlink.

As shown by reference 602, the network node 110 may transmit, and the UE 120 may receive, a trigger indicating that the UE 120 is to perform a GNSS acquisition process within a GNSS measurement gap. In some aspects, a start time of the GNSS measurement gap may be based at least in part on whether HARQ feedback is enabled for a channel in which the trigger is received, as described, for example, with respect to FIG. 4.

As shown by reference 604, the UE 120 may, in some aspects, perform the GNSS acquisition process within the GNSS measurement gap based at least in part on the trigger. For example, the UE 120 may determine that a remaining GNSS validity duration fails to satisfy a threshold (e.g., is less than a minimum remaining GNSS validity duration) and, therefore, may perform the GNSS acquisition process within the GNSS measurement gap. In example 600, a result of performing the GNSS acquisition process is a failure to reacquire GNSS within the GNSS measurement gap. That is, the UE 120 fails to reacquire GNSS within the GNSS measurement gap. A failure to reacquire GNSS may result due to, for example, a change of GNSS satellites in range of the UE 120, bad radio conditions, or interference, among other examples.

As shown by reference 606, the UE 120 may perform a GNSS failure recovery process based at least in part on the failure to reacquire GNSS within the GNSS measurement gap.

In some aspects, performing the GNSS failure recovery process includes performing a fallback operation. In some aspects, the fallback operation may include moving to operation in an RRC idle mode (e.g., from operation in an RRC connected mode). For example, the UE 120 may release an RRC connection and enter the RRC idle mode, meaning that the UE 120 is reachable via paging or random access. Additionally, or alternatively, the fallback operation may include performing a radio link failure (RLF) recovery process. For example, the UE 120 may perform cell selection and perform an RRC reestablishment procedure. In some aspects, prior to performing the fallback operation (e.g., moving to RRC idle mode or performing the RLF recovery process), the UE 120 may attempt to reacquire GNSS before performing random access.

In some aspects, the UE 120 may perform the fallback operation regardless of whether a GNSS validity duration is expired. That is, the UE 120 may be configured to consider the GNSS validity duration expired (regardless of whether the GNSS validity duration is actually expired) and perform the fallback operation.

Additionally, or alternatively, the UE 120 may perform the fallback operation based at least in part on a determination that the GNSS validity duration is expired. That is, the UE 120 may determine that the GNSS validity duration has expired. Here, based on the determination that the GNSS validity duration has expired, the UE 120 may perform the fallback operation.

Additionally, or alternatively, the UE 120 may perform the fallback operation based at least in part on a determination that the remaining GNSS validity duration fails to satisfy a threshold. For example, the UE 120 may determine that the GNSS validity duration has not expired. However, the UE 120 may determine that a remaining GNSS validity duration from an end of the GNSS measurement gap fails to satisfy (e.g., is less than) a threshold of Z ms (Z≥0). In this example, the UE 120 may then perform the fallback operation based at least in part on the determination that the remaining GNSS validity duration fails to satisfy the threshold. In some aspects, the threshold of Z ms may be determined as a minimum of a set of configured validity duration codepoints. Additionally, or alternatively, the threshold of Z ms may be configured on the UE 120 (e.g., via unicast RRC signaling).

In some aspects, performing the GNSS failure recovery process includes transmitting a GNSS failure recovery indication. In some aspects, the GNSS failure recovery indication may transmitted in a MAC-CE. In some aspects, the GNSS failure recovery indication includes an indication of a remaining GNSS validity duration. Additionally, or alternatively, the GNSS failure recovery indication may include an indication of an unsuccessful GNSS reacquisition (e.g., a codepoint indicating an unsuccessful GNSS reacquisition). In some aspects, the UE 120 may perform a random access procedure in association with transmitting the GNSS failure recovery indication.

In some aspects, the UE 120 transmits the GNSS failure recovery indication based at least in part on a determination that the GNSS validity duration is not expired. That is, the UE 120 may determine that the GNSS validity duration has not expired. Here, based on the determination that the GNSS validity duration has not expired, the UE 120 may transmit the GNSS failure recovery indication.

Additionally, or alternatively, the UE 120 may transmit the GNSS failure recovery indication based at least in part on a determination that the remaining GNSS validity duration satisfies a threshold. For example, the UE 120 may determine that the GNSS validity duration has not expired. Further, the UE 120 may determine that a remaining GNSS validity duration satisfies (e.g., is greater than or equal to) the threshold of Z ms. In this example, the UE 120 may then transmit the GNSS failure recovery indication based at least in part on the determination that the remaining GNSS validity duration satisfies the threshold.

In some aspects, a manner in which the UE 120 handles a GNSS reacquisition failure may be configured on the UE 120 (e.g., according to an applicable wireless communication standard or based on network configuration) or may depend on one or more other factors. For example, if UE-autonomous GNSS measurement gaps are not configured for the UE 120, then the UE 120 may be configured to perform the fallback operation regardless of whether a GNSS validity duration is expired. Alternatively, if UE-autonomous GNSS measurement gaps are configured for the UE 120, then the UE 120 may be configured to selectively perform the fallback operation or transmit a GNSS failure recovery indication based at least in part on whether a GNSS validity duration has expired.

FIG. 6B is a diagram illustrating an example in which the UE 120 performs the fallback operation regardless of whether the GNSS validity duration is expired.

FIG. 6C is a diagram illustrating an example in which the UE 120 transmits a GNSS failure recovery indication based at least in part on a determination that a GNSS validity duration has not expired. In this example, the GNSS failure recovery indication indicates the remaining GNSS validity duration (e.g., Y ms).

FIG. 6D is a diagram illustrating an example in which the UE 120 performs the fallback operation based at least in part on a determination that a remaining GNSS validity duration fails to satisfy a threshold (e.g., that the remaining GNSS validity duration is less than Z ms).

FIG. 6E is a diagram illustrating an example in which the UE 120 transmits a GNSS failure recovery indication based at least in part on a determination that a GNSS validity duration has not expired and that a remaining GNSS validity duration satisfies a threshold (e.g., that the remaining GNSS validity duration from the end of the GNSS measurement gap is greater than or equal to Z ms). In this example, the GNSS failure recovery indication indicates the remaining GNSS validity duration (e.g., Y ms).

As indicated above, FIGS. 6A-6E are provided as examples. Other examples may differ from what is described with respect to FIGS. 6A-6E.

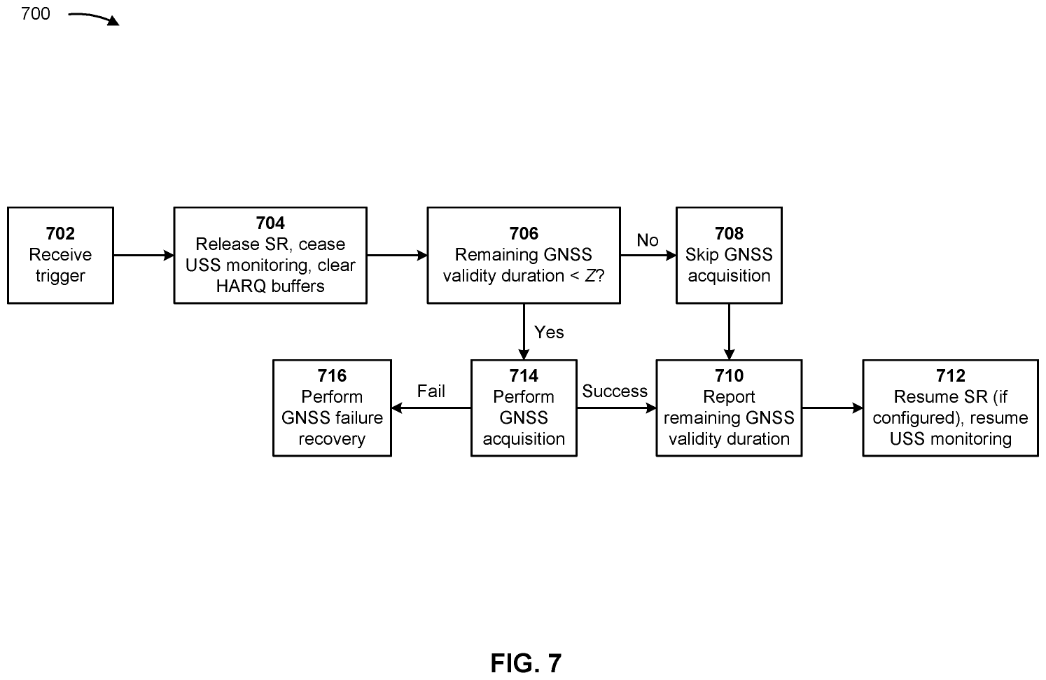

FIG. 7 is a diagram illustrating an example process 700 associated with GNSS operation with triggered gaps, in accordance with the present disclosure.

As shown in FIG. 7 starting at block 702, the UE 120 may receive a trigger indicating that the UE 120 is to perform a GNSS acquisition process within a GNSS measurement gap.

As shown at block 704, the UE 120 may, in some aspects, be configured to perform one or more operations based at least in part on receiving the trigger. As shown, such operations may include releasing a set of scheduling request (SR) resources, ceasing UE-specific search space (USS) monitoring, or clearing HARQ buffers, among other examples. Notably, such operations may, in some aspects, be performed after a determination that a remaining GNSS validity duration satisfies a threshold, as described below (e.g., the operations of block 704 may be performed between the operations of block 706 and block 714).

As shown at block 706, the UE 120 may determine whether a remaining GNSS validity duration associated with the UE 120 satisfies a threshold (e.g., whether the remaining GNSS validity duration is less than a threshold of Z ms).

As shown at block 708, if the UE 120 determines that the remaining GNSS validity duration associated with the UE 120 fails to satisfy the threshold (e.g., that the remaining GNSS validity duration greater than or equal to Z ms) (block 706→No), then the UE 120 may skip performing the GNSS acquisition process in the GNSS measurement gap. As shown at block 710, the UE 120 may then report the remaining GNSS validity duration and, as shown at block 712, may resume using the set of scheduling request resources (if still configured) and may resume USS monitoring.

Conversely, as shown at block 714, if the UE 120 determines that the remaining GNSS validity duration associated with the UE 120 satisfies the threshold (e.g., that the remaining GNSS validity duration is less than Z ms) (block 706→Yes), then the UE 120 may perform the GNSS acquisition process within the GNSS measurement gap.

As shown, if the UE 120 successfully reacquires GNSS within the GNSS measurement gap (block 714→Success), then the UE 120 may report the remaining GNSS validity duration, as shown at block 710, and resume using the set of scheduling request resources (if still configured) and resume USS monitoring, as shown at block 712.

Conversely, if the UE 120 fails to reacquire GNSS within the GNSS measurement gap (block 714→Fail), then the UE 120 may perform the GNSS failure recovery process, as shown at block 716 (e.g., perform a fallback operation, transmit a GNSS failure recovery indication, or the like).

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with GNSS operation with triggered gaps.

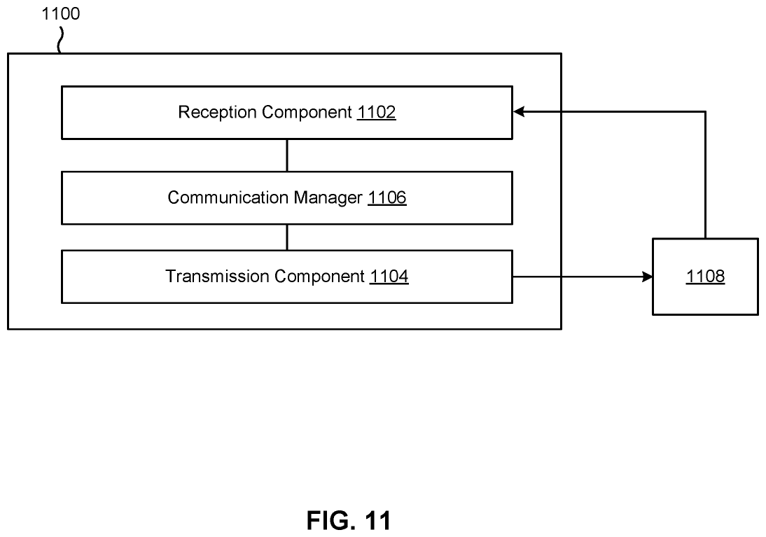

As shown in FIG. 8, in some aspects, process 800 may include receiving a trigger indicating that the UE is to perform a GNSS acquisition process within a GNSS measurement gap, wherein a start time of the GNSS measurement gap is based at least in part on whether HARQ feedback is enabled for a channel in which the trigger is received (block 810). For example, the UE (e.g., using reception component 1102 and/or communication manager 1106, depicted in FIG. 11) may receive a trigger indicating that the UE is to perform a GNSS acquisition process within a GNSS measurement gap, wherein a start time of the GNSS measurement gap is based at least in part on whether HARQ feedback is enabled for a channel in which the trigger is received, as described above.

As further shown in FIG. 8, in some aspects, process 800 may include performing the GNSS acquisition process within the GNSS measurement gap based at least in part on the trigger (block 820). For example, the UE (e.g., using communication manager 1106, depicted in FIG. 11) may perform the GNSS acquisition process within the GNSS measurement gap based at least in part on the trigger, as described above.

Process 800 may include additional aspects, such as any single aspect or any combination of aspects described below and/or in connection with one or more other processes described elsewhere herein.

In a first aspect, the start time of the GNSS measurement gap is a particular amount of time after a transmission of a HARQ acknowledgment associated with the trigger based on HARQ feedback being enabled for the channel in which the trigger is received.

In a second aspect, alone or in combination with the first aspect, the start time of the GNSS measurement gap is a particular amount of time after an end of reception of the channel in which the trigger is received based on HARQ feedback being disabled for the channel in which the trigger is received.

In a third aspect, alone or in combination with one or more of the first through third aspects, performing the GNSS acquisition process comprises performing the GNSS acquisition process based at least in part on a determination that a remaining GNSS validity duration fails to satisfy a threshold.

In a fourth aspect, alone or in combination with one or more of the first through fourth aspects, performing the GNSS acquisition process comprises performing the GNSS acquisition process, wherein a result of performing the GNSS acquisition process is a failure to reacquire GNSS within the GNSS measurement gap, and performing a GNSS failure recovery process based at least in part on the failure to reacquire GNSS within the GNSS measurement gap.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with GNSS operation for triggered gaps.

As shown in FIG. 9, in some aspects, process 900 may include receiving a trigger indicating that the UE is to perform a GNSS acquisition process within a GNSS measurement gap (block 910). For example, the UE (e.g., using reception component 1102 and/or communication manager 1106, depicted in FIG. 11) may receive a trigger indicating that the UE is to perform a GNSS acquisition process within a GNSS measurement gap, as described above.

As further shown in FIG. 9, in some aspects, process 900 may include selectively performing the GNSS acquisition process within the GNSS measurement gap based at least in part on a determination of whether a remaining GNSS validity duration satisfies a threshold (block 920). For example, the UE (e.g., using communication manager 1106, depicted in FIG. 11) may selectively perform the GNSS acquisition process within the GNSS measurement gap based at least in part on a determination of whether a remaining GNSS validity duration satisfies a threshold, as described above.

Process 900 may include additional aspects, such as any single aspect or any combination of aspects described below and/or in connection with one or more other processes described elsewhere herein.

In a first aspect, the threshold is configured on the UE.

In a second aspect, alone or in combination with the first aspect, the threshold corresponds to a fraction of a GNSS validity duration.

In a third aspect, alone or in combination with one or more of the first and second aspects, the threshold is indicated in a configuration received from a network node.

In a fourth aspect, alone or in combination with one or more of the first through third aspects, the threshold is signaled by the UE in at least one of UE capability information or UE assistance information.

In a fifth aspect, alone or in combination with one or more of the first through fourth aspects, selectively performing the GNSS acquisition process comprises refraining from performing the GNSS acquisition process based at least in part on a determination that the remaining GNSS validity duration satisfies the threshold.

In a sixth aspect, alone or in combination with one or more of the first through fifth aspects, process 900 includes transmitting an indication of the remaining GNSS validity duration.

In a seventh aspect, alone or in combination with one or more of the first through sixth aspects, process 900 includes releasing a set of scheduling request resources, and performing a contention-based random access procedure in association with transmitting the indication of the remaining GNSS validity duration.

In an eighth aspect, alone or in combination with one or more of the first through seventh aspects, process 900 includes refraining from releasing a set of scheduling request resources, and transmitting a scheduling request in the set of scheduling request resources.

In a ninth aspect, alone or in combination with one or more of the first through eighth aspects, process 900 includes receiving an uplink grant after transmitting the scheduling request, and transmitting the indication of the remaining GNSS validity duration based at least in part on the uplink grant.

In a tenth aspect, alone or in combination with one or more of the first through ninth aspects, the set of scheduling request resources is valid for a period of time starting from an end of reception of the channel in which the trigger is received or from a transmission of a HARQ acknowledgment associated with the trigger.

In an eleventh aspect, alone or in combination with one or more of the first through tenth aspects, process 900 includes releasing the set of scheduling request resources if no grant has been received during a period of time starting from an end of reception of the channel in which the trigger is received or from a transmission of a HARQ acknowledgment associated with the trigger.

In a twelfth aspect, alone or in combination with one or more of the first through eleventh aspects, process 900 includes transmitting an indication that the UE refrained from performing the GNSS acquisition process.

In a thirteenth aspect, alone or in combination with one or more of the first through twelfth aspects, the indication that the UE refrained from performing the GNSS acquisition process is transmitted via HARQ feedback associated with the trigger.

In a fourteenth aspect, alone or in combination with one or more of the first through thirteenth aspects, selectively performing the GNSS acquisition process comprises performing the GNSS acquisition process based at least in part on a determination that the remaining GNSS validity duration fails to satisfy the threshold.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with GNSS with triggered gaps.

As shown in FIG. 10, in some aspects, process 1000 may include receiving a trigger indicating that the UE is to perform a GNSS acquisition process within a GNSS measurement gap (block 1010). For example, the UE (e.g., using reception component 1102 and/or communication manager 1106, depicted in FIG. 11) may receive a trigger indicating that the UE is to perform a GNSS acquisition process within a GNSS measurement gap, as described above.

As further shown in FIG. 10, in some aspects, process 1000 may include performing the GNSS acquisition process within the GNSS measurement gap based at least in part on the trigger, wherein a result of performing the GNSS acquisition process is a failure to reacquire GNSS within the GNSS measurement gap (block 1020). For example, the UE (e.g., using communication manager 1106, depicted in FIG. 11) may perform the GNSS acquisition process within the GNSS measurement gap based at least in part on the trigger, wherein a result of performing the GNSS acquisition process is a failure to reacquire GNSS within the GNSS measurement gap, as described above. In some aspects, a result of performing the GNSS acquisition process is a failure to reacquire GNSS within the GNSS measurement gap.

As further shown in FIG. 10, in some aspects, process 1000 may include performing a GNSS failure recovery process based at least in part on the failure to reacquire GNSS within the GNSS measurement gap (block 1030). For example, the UE (e.g., using communication manager 1106, depicted in FIG. 11) may perform a GNSS failure recovery process based at least in part on the failure to reacquire GNSS within the GNSS measurement gap, as described above.

Process 1000 may include additional aspects, such as any single aspect or any combination of aspects described below and/or in connection with one or more other processes described elsewhere herein.

In a first aspect, the GNSS failure recovery process comprises performing a fallback operation.

In a second aspect, alone or in combination with the first aspect, the fallback operation is performed regardless of whether a GNSS validity duration is expired.

In a third aspect, alone or in combination with one or more of the first and second aspects, the fallback operation is performed based at least in part on a determination that a GNSS validity duration is expired.

In a fourth aspect, alone or in combination with one or more of the first through third aspects, the fallback operation is performed based at least in part on a determination that a remaining GNSS validity duration fails to satisfy a threshold.

In a fifth aspect, alone or in combination with one or more of the first through fourth aspects, the fallback operation comprises at least one of moving to operation in an RRC idle mode or performing an RLF recovery process.

In a sixth aspect, alone or in combination with one or more of the first through fifth aspects, the GNSS failure recovery process comprises transmitting a GNSS failure recovery indication, wherein the GNSS failure recovery indication includes at least one of an indication of a remaining GNSS validity duration or an indication of an unsuccessful GNSS reacquisition.

In a seventh aspect, alone or in combination with one or more of the first through sixth aspects, the GNSS failure recovery indication is transmitted based at least in part on a determination that a GNSS validity duration is not expired.

In an eighth aspect, alone or in combination with one or more of the first through seventh aspects, the GNSS failure recovery indication is transmitted based at least in part on a determination that a remaining GNSS validity duration satisfies a threshold.

In a ninth aspect, alone or in combination with one or more of the first through eighth aspects, process 1000 includes performing a random access procedure in association with transmitting the GNSS failure recover indication.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-7. Additionally, or alternatively, the apparatus 1100 may be configured to perform one or more processes described herein, such as process 800 of FIG. 8, process 900 of FIG. 9, process 1000 of FIG. 10, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

In some aspects, the reception component 1102 may receive a trigger indicating that the UE is to perform a GNSS acquisition process within a GNSS measurement gap, wherein a start time of the GNSS measurement gap is based at least in part on whether HARQ feedback is enabled for a channel in which the trigger is received. The communication manager 1106 may perform the GNSS acquisition process within the GNSS measurement gap based at least in part on the trigger. In some implementations, the communication manager 1106 may selectively perform the GNSS acquisition process within the GNSS measurement gap.

In some aspects, the reception component 1102 may receive a trigger indicating that the UE is to perform a global navigation satellite system (GNSS) acquisition process within a GNSS measurement gap. The communication manager 1106 may perform the GNSS acquisition process within the GNSS measurement gap based at least in part on a determination of whether a remaining GNSS validity duration satisfies a threshold.

In some aspects, the transmission component 1104 may transmit an indication of the remaining GNSS validity duration.

In some aspects, the communication manager 1106 may release a set of scheduling request resources.

In some aspects, the communication manager 1106 may perform a contention-based random access procedure in association with transmitting the indication of the remaining GNSS validity duration.

In some aspects, the communication manager 1106 may refrain from releasing a set of scheduling request resources.

In some aspects, the transmission component 1104 may transmit a scheduling request in the set of scheduling request resources.

In some aspects, the reception component 1102 may receive an uplink grant after transmitting the scheduling request.

In some aspects, the transmission component 1104 may transmit the indication of the remaining GNSS validity duration based at least in part on the uplink grant.

In some aspects, the communication manager 1106 may release the set of scheduling request resources if no grant has been received during a period of time starting from an end of reception of the channel in which the trigger is received or from a transmission of a HARQ acknowledgment associated with the trigger.

In some aspects, the transmission component 1104 may transmit an indication that the UE refrained from performing the GNSS acquisition process.

In some aspects, the reception component 1102 may receive a trigger indicating that the UE is to perform a GNSS acquisition process within a GNSS measurement gap. The communication manager 1106 may perform the GNSS acquisition process within the GNSS measurement gap based at least in part on the trigger, wherein a result of performing the GNSS acquisition process is a failure to reacquire GNSS within the GNSS measurement gap. The communication manager 1106 may perform a GNSS failure recovery process based at least in part on the failure to reacquire GNSS within the GNSS measurement gap.

In some aspects, the communication manager 1106 may perform a random access procedure in association with transmitting the GNSS failure recover indication.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving a trigger indicating that the UE is to perform a GNSS acquisition process within a GNSS measurement gap, wherein a start time of the GNSS measurement gap is based at least in part on whether HARQ feedback is enabled for a channel in which the trigger is received; and performing the GNSS acquisition process within the GNSS measurement gap based at least in part on the trigger.

Aspect 2: The method of Aspect 1, wherein the start time of the GNSS measurement gap is a particular amount of time after a transmission of a HARQ acknowledgment associated with the trigger based on HARQ feedback being enabled for the channel in which the trigger is received.

Aspect 3: The method of any of Aspects 1-2, wherein the start time of the GNSS measurement gap is a particular amount of time after an end of reception of the channel in which the trigger is received based on HARQ feedback being disabled for the channel in which the trigger is received.

Aspect 4: The method of any of Aspects 1-3, wherein performing the GNSS acquisition process comprises performing the GNSS acquisition process based at least in part on a determination that a remaining GNSS validity duration fails to satisfy a threshold.

Aspect 5: The method of any of Aspects 1-4, wherein performing the GNSS acquisition process comprises: performing the GNSS acquisition process, wherein a result of performing the GNSS acquisition process is a failure to reacquire GNSS within the GNSS measurement gap; and performing a GNSS failure recovery process based at least in part on the failure to reacquire GNSS within the GNSS measurement gap.

Aspect 6: A method of wireless communication performed by a UE, comprising: receiving a trigger indicating that the UE is to perform a GNSS acquisition process within a GNSS measurement gap; and selectively performing the GNSS acquisition process within the GNSS measurement gap based at least in part on a determination of whether a remaining GNSS validity duration satisfies a threshold.

Aspect 7: The method of Aspect 6, wherein the threshold is configured on the UE.

Aspect 8: The method of any of Aspects 6-7, wherein the threshold corresponds to a fraction of a GNSS validity duration.

Aspect 9: The method of any of Aspects 6-8, wherein the threshold is indicated in a configuration received from a network node.

Aspect 10: The method of any of Aspects 6-90, wherein the threshold is signaled by the UE in at least one of UE capability information or UE assistance information.

Aspect 11: The method of any of Aspects 6-10, wherein selectively perform the GNSS acquisition process comprises refraining from performing the GNSS acquisition process based at least in part on a determination that the remaining GNSS validity duration satisfies the threshold.

Aspect 12: The method of Aspect 11, further comprising transmitting an indication of the remaining GNSS validity duration.

Aspect 13: The method of Aspect 12, further comprising: releasing a set of scheduling request resources; and performing a contention-based random access procedure in association with transmitting the indication of the remaining GNSS validity duration.

Aspect 14: The method of Aspect 12, further comprising: refraining from releasing a set of scheduling request resources; and transmitting a scheduling request in the set of scheduling request resources.

Aspect 15: The method of Aspect 14, further comprising: receiving an uplink grant after transmitting the scheduling request; and transmitting the indication of the remaining GNSS validity duration based at least in part on the uplink grant.

Aspect 16: The method of Aspect 14, wherein the set of scheduling request resources is valid for a period of time starting from an end of reception of the channel in which the trigger is received or from a transmission of a hybrid automatic repeat request (HARQ) acknowledgment associated with the trigger.

Aspect 17: The method of Aspect 14, further comprising releasing the set of scheduling request resources if no grant has been received during a period of time starting from an end of reception of the channel in which the trigger is received or from a transmission of a HARQ acknowledgment associated with the trigger.

Aspect 18: The method of Aspect 11, further comprising transmitting an indication that the UE refrained from performing the GNSS acquisition process.

Aspect 19: The method of Aspect 18, wherein the indication that the UE refrained from performing the GNSS acquisition process is transmitted via HARQ feedback associated with the trigger.

Aspect 20: The method of any of Aspects 6-19, wherein selectively perform the GNSS acquisition process comprises performing the GNSS acquisition process based at least in part on a determination that the remaining GNSS validity duration fails to satisfy the threshold.

Aspect 21: A method of wireless communication performed by a UE, comprising: receiving a trigger indicating that the UE is to perform a GNSS acquisition process within a GNSS measurement gap; performing the GNSS acquisition process within the GNSS measurement gap based at least in part on the trigger, wherein a result of performing the GNSS acquisition process is a failure to reacquire GNSS within the GNSS measurement gap; and performing a GNSS failure recovery process based at least in part on the failure to reacquire GNSS within the GNSS measurement gap.

Aspect 22: The method of Aspect 21, wherein the GNSS failure recovery process comprises performing a fallback operation.

Aspect 23: The method of Aspect 22, wherein the fallback operation is performed regardless of whether a GNSS validity duration is expired.

Aspect 24: The method of Aspect 22, wherein the fallback operation is performed based at least in part on a determination that a GNSS validity duration is expired.

Aspect 25: The method of Aspect 22, wherein the fallback operation is performed based at least in part on a determination that a remaining GNSS validity duration fails to satisfy a threshold.

Aspect 26: The method of Aspect 22, wherein the fallback operation comprises at least one of moving to operation in an RRC idle mode or performing an RLF recovery process.

Aspect 27: The method of any of Aspects 21-26, wherein the GNSS failure recovery process comprises transmitting a GNSS failure recovery indication, wherein the GNSS failure recovery indication includes at least one of an indication of a remaining GNSS validity duration or an indication of an unsuccessful GNSS reacquisition.

Aspect 28: The method of Aspect 278, wherein the GNSS failure recovery indication is transmitted based at least in part on a determination that a GNSS validity duration is not expired.

Aspect 29: The method of Aspect 27, wherein the GNSS failure recovery indication is transmitted based at least in part on a determination that a remaining GNSS validity duration satisfies a threshold.

Aspect 30: The method of Aspect 27, further comprising performing a random access procedure in association with transmitting the GNSS failure recover indication.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive a trigger indicating that the UE is to perform a global navigation satellite system (GNSS) acquisition process within a GNSS measurement gap,
wherein a start time of the GNSS measurement gap is based at least in part on whether hybrid automatic repeat request (HARQ) feedback is enabled for a channel in which the trigger is received; and
perform the GNSS acquisition process within the GNSS measurement gap based at least in part on the trigger.

2. The UE of claim 1, wherein the start time of the GNSS measurement gap is a particular amount of time after a transmission of a HARQ acknowledgment associated with the trigger based on HARQ feedback being enabled for the channel in which the trigger is received.

3. The UE of claim 1, wherein the start time of the GNSS measurement gap is a particular amount of time after an end of reception of the channel in which the trigger is received based on HARQ feedback being disabled for the channel in which the trigger is received.

4. The UE of claim 1, wherein the one or more processors, to perform the GNSS acquisition process, are configured to perform the GNSS acquisition process based at least in part on a determination that a remaining GNSS validity duration fails to satisfy a threshold.

5. The UE of claim 1, wherein the one or more processors, to perform the GNSS acquisition process, are configured to:
perform the GNSS acquisition process, wherein a result of performing the GNSS acquisition process is a failure to reacquire GNSS within the GNSS measurement gap; and
perform a GNSS failure recovery process based at least in part on the failure to reacquire GNSS within the GNSS measurement gap.

6. A user equipment (UE) for wireless communication, comprising:
a memory; and
one or more processors, coupled to the memory, configured to:
receive a trigger indicating that the UE is to perform a global navigation satellite system (GNSS) acquisition process within a GNSS measurement gap; and
selectively perform the GNSS acquisition process within the GNSS measurement gap based at least in part on a determination of whether a remaining GNSS validity duration satisfies a threshold.

7. The UE of claim 7, wherein the threshold is configured on the UE.

8. The UE of claim 7, wherein the threshold corresponds to a fraction of a GNSS validity duration.

9. The UE of claim 7, wherein the threshold is indicated in a configuration received from a network node.

10. The UE of claim 7, wherein the threshold is signaled by the UE in at least one of UE capability information or UE assistance information.

11. The UE of claim 7, wherein the one or more processors, to selectively perform the GNSS acquisition process, are configured to refrain from performing the GNSS acquisition process based at least in part on a determination that the remaining GNSS validity duration satisfies the threshold.

12. The UE of claim 12, wherein the one or more processors are further configured to transmit an indication of the remaining GNSS validity duration.

13. The UE of claim 13, wherein the one or more processors are further configured to:
release a set of scheduling request resources; and
perform a contention-based random access procedure in association with transmitting the indication of the remaining GNSS validity duration.

14. The UE of claim 13, wherein the one or more processors are further configured to:
refrain from releasing a set of scheduling request resources; and
transmit a scheduling request in the set of scheduling request resources.

15. The UE of claim 15, wherein the one or more processors are further configured to:
receive an uplink grant after transmitting the scheduling request; and
transmit the indication of the remaining GNSS validity duration based at least in part on the uplink grant.

16. The UE of claim 15, wherein the set of scheduling request resources is valid for a period of time starting from an end of reception of a channel in which the trigger is received or from a transmission of a hybrid automatic repeat request (HARQ) acknowledgment associated with the trigger.

17. The UE of claim 15, wherein the one or more processors are further configured to release the set of scheduling request resources if no grant has been received during a period of time starting from an end of reception of a channel in which the trigger is received or from a transmission of a hybrid automatic repeat request (HARQ) acknowledgment associated with the trigger.

18. The UE of claim 12, wherein the one or more processors are further configured to transmit an indication that the UE refrained from performing the GNSS acquisition process.

19. The UE of claim 19, wherein the indication that the UE refrained from performing the GNSS acquisition process is transmitted via hybrid automatic repeat request (HARQ) feedback associated with the trigger.

20. The UE of claim 7, wherein the one or more processors, to selectively perform the GNSS acquisition process, are configured to perform the GNSS acquisition process based at least in part on a determination that the remaining GNSS validity duration fails to satisfy the threshold.

21. A user equipment (UE) for wireless communication, comprising:
a memory; and
one or more processors, coupled to the memory, configured to:
receive a trigger indicating that the UE is to perform a global navigation satellite system (GNSS) acquisition process within a GNSS measurement gap;
perform the GNSS acquisition process within the GNSS measurement gap based at least in part on the trigger,
wherein a result of performing the GNSS acquisition process is a failure to reacquire GNSS within the GNSS measurement gap; and
perform a GNSS failure recovery process based at least in part on the failure to reacquire GNSS within the GNSS measurement gap.

22. The UE of claim 21, wherein the GNSS failure recovery process comprises performing a fallback operation.

23. The UE of claim 22, wherein the fallback operation is performed regardless of whether a GNSS validity duration is expired.

24. The UE of claim 22, wherein the fallback operation is performed based at least in part on a determination that a GNSS validity duration is expired.

25. The UE of claim 22, wherein the fallback operation is performed based at least in part on a determination that a remaining GNSS validity duration fails to satisfy a threshold.

26. The UE of claim 22, wherein the fallback operation comprises at least one of moving to operation in a radio resource control (RRC) idle mode or performing a radio link failure (RLF) recovery process.

27. The UE of claim 21, wherein the GNSS failure recovery process comprises transmitting a GNSS failure recovery indication, wherein the GNSS failure recovery indication includes at least one of an indication of a remaining GNSS validity duration or an indication of an unsuccessful GNSS reacquisition.

28. The UE of claim 27, wherein the GNSS failure recovery indication is transmitted based at least in part on a determination that a GNSS validity duration is not expired.

29. The UE of claim 27, wherein the GNSS failure recovery indication is transmitted based at least in part on a determination that a remaining GNSS validity duration satisfies a threshold.

30. The UE of claim 27, wherein the one or more processors are further configured to perform a random access procedure in association with transmitting the GNSS failure recover indication.
